(19) United States
(12) Patent Application Publication
(10) Pub. No.: US 2018/0057324 A1
(43) Pub. Date: Mar. 1, 2018

(54) CAPSTAN EXTERNAL FLAGPOLE WINCH

(71) Applicant: Charles Angus Gourley, Bethel, CT (US)

(72) Inventor: Charles Angus Gourley, Bethel, CT (US)

(21) Appl. No.: 15/498,901

(22) Filed: Apr. 27, 2017

Related U.S. Application Data
(60) Provisional application No. 62/380,621, filed on Aug. 29, 2016.

(51) Int. Cl. B66D 1/74; E04H 12/32; G09F 17/00

(52) U.S. Cl. CPC B66D 1/7489; E04H 12/32; G09F 2017/0025; B66D 1/7442; G09F 17/00

(57) ABSTRACT

An external capstan winch for a closed-loop halyard is provided. The external capstan winch enables the closed loop halyard whose ends are interconnected by a tension device facilitating positive raising and lowering of the an object attached to the halyard. The external capstan winch includes a drive/latching assembly for selectively raising and lowering the flag connected to the halyard without the need for weights. The external capstan winch provides a spool with peripheral cleats for grabbing the halyard as the capstan spool revolves relative to its winch, preventing the halyard from getting twisted and tangled, and as a corollary eliminating the need for a cleat halyard system.

### CROSS-REFERENCE TO RELATED APPLICATION

This application claims the benefit of priority of U.S. provisional application No. 62/380,621, filed 29 Aug. 2016, the contents of which are herein incorporated by reference.

### BACKGROUND OF THE INVENTION

The present invention relates to winches and, more particularly, a winch providing an external capstan spool enabling a closed loop halyard, whereby a tension device interconnects the opposing ends of the halyard so that the associated drive/latching assembly for raising and lowering an object attached to the halyard, such as a flag, may be selectively operated by a household power drill or handheld crank tool, thereby obviating the need to add weights to the halyard.

For a long time now a flag is raised and lowered along a flagpole by way of a halyard connected to a winch internalized by the flagpole. Such an internal halyard is lowered by gravity from weights or mass attached to the halyard, which in windy conditions bangs against the pole making the loud clanging noise that is familiar to many. The flagpole of the concealed halyard typically includes a hollow column having a rotatable truck assembly at its upper end, wherein the halyard is strung from the winch up through the truck over its pulleys and downward outside the column, its end being attached to a mass, typically weighted beads, which may encircle the pole. The winch is disposed inside the column, wherein the column is apertured to pass the driving end of the crank. The access door is provided in the wall of the hollow column to permit use and servicing of the winch assembly.

Currently, there is no winch in the industry that is mounted on the outside of the flagpole; rather they are internally mounted inside the flagpole. In cranking up or down with an internal winch the cable can easily get twisted and tangled. Also, the weight which lowers the flag can get caught on itself or on objects on the pole.

Furthermore, such flagpoles have a cleat halyard system where the halyard is fastened to the cleat, less the added weight lower the flag. Flags can easily be stolen when they are secured this way, as the thief just has to decleat the halyard.

As can be seen, there is a need for a pole winch providing an external capstan spool allowing the halyard to be self-contained or closed looped, whereby a tension device interconnects the opposing ends of the halyard, so that the associated drive/latching assembly for raising and lowering a flag may be selectively operated by a household power drill or handheld crank tool without the need of weights. Furthermore, the external capstan winch with the tensioned closed-loop halyard does not need the cleat halyard system, and so making flag stealing more difficult.

### SUMMARY OF THE INVENTION

In one aspect of the present invention, a flagpole winch system includes a winch attached along an exterior of a flagpole; a capstan spool rotatably mounted to the winch; and a closed-loop halyard engaging the capstan spool.

In another aspect of the present invention, the flagpole winch system includes a winch attached along an exterior of a flagpole; a capstan spool rotatably mounted to the winch; spaced apart peripheral cleats provided along a periphery of the capstan spool, wherein said periphery has a narrower center diameter relative to diameters of first and second ends thereof, and wherein the spaced apart peripheral cleats extend longitudinally between said first and second ends; and a closed-loop halyard engaging the capstan spool, wherein the closed-loop halyard incorporates a tension device.

In yet another aspect of the present invention, a winch system includes a capstan spool rotatably mounted to the winch; a closed-loop halyard engaging the capstan spool; spaced apart peripheral cleats provided along a periphery of the capstan spool, wherein said periphery has a narrower center diameter relative to diameters of first and second ends thereof, and wherein the spaced apart peripheral cleats extend longitudinally between said first and second ends; and a tension device incorporated in the closed-loop halyard.

These and other features, aspects and advantages of the present invention will become better understood with reference to the following drawings, description and claims.

### BRIEF DESCRIPTION OF THE DRAWINGS

FIG. 1 is a front perspective view of an exemplary embodiment of the present invention, shown in use on a flagpole 58 with cranking tool 64;

FIG. 2 is a rear perspective view of an exemplary embodiment of the present invention;

FIG. 3 is a rear exploded view of an exemplary embodiment of the present invention;

FIG. 4 is a section view of an exemplary embodiment of the present invention, taken along line 4-4 of FIG. 2 with a cranking tool and a halyard shown for clarity;

FIG. 5 is a section view of an exemplary embodiment of the present invention, taken along line 5-5 of FIG. 4;

FIG. 6 is a section view of an exemplary embodiment of the present invention, illustrating the first movement of rotation with pawls plates 24 and 30 compressing to allow rotation of rollers 26 and 32; and

FIG. 7 is a section view of an exemplary embodiment of the present invention, showing the rollers having been rotated one position in plate guides 14.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an external capstan winch enabling a closed loop halyard, the ends of the halyard being interconnected by a tension device facilitating positive raising and lowering of the flag without the use of additional weight. The external capstan winch includes a drive/latching assembly for selectively raising and lowering the flag connected to the halyard. The external capstan winch provides a spool with peripheral cleats for grabbing the halyard as the capstan spool revolves relative to its winch, preventing the halyard from getting twisted and tangled, and as a corollary eliminating the need for a cleat halyard system when used with the tensioned closed-loop halyard.

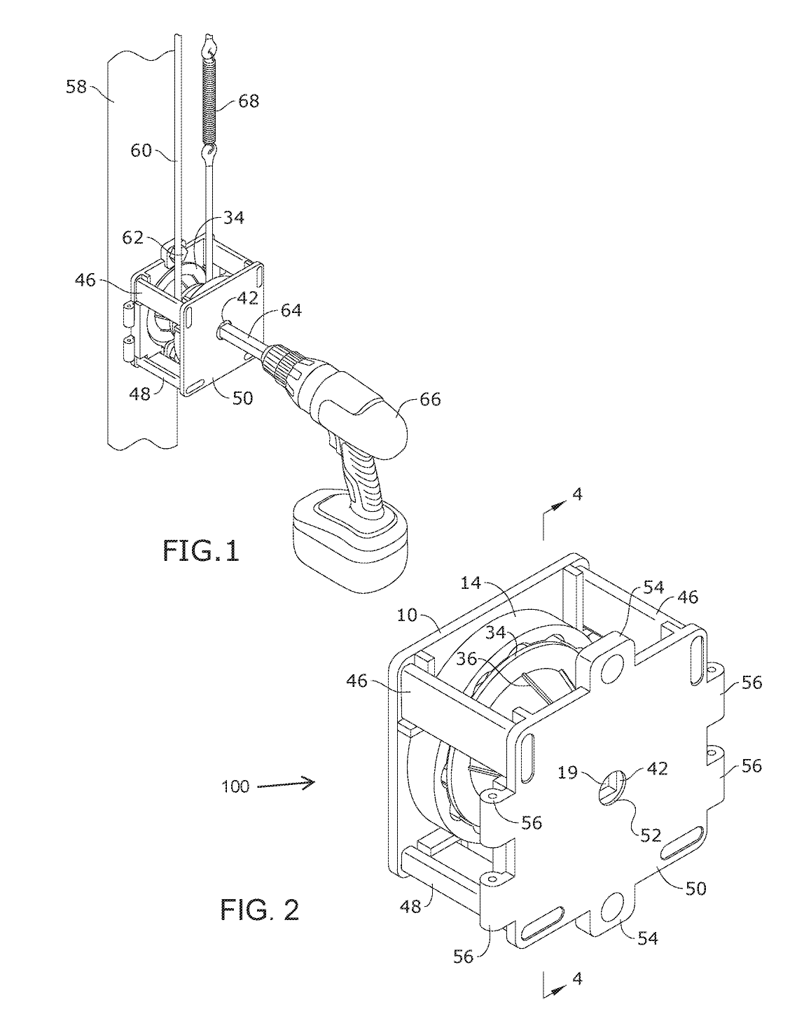

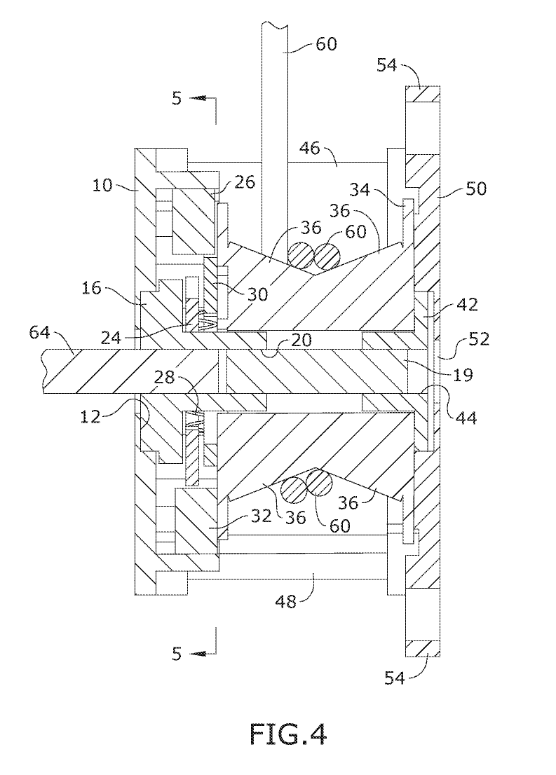

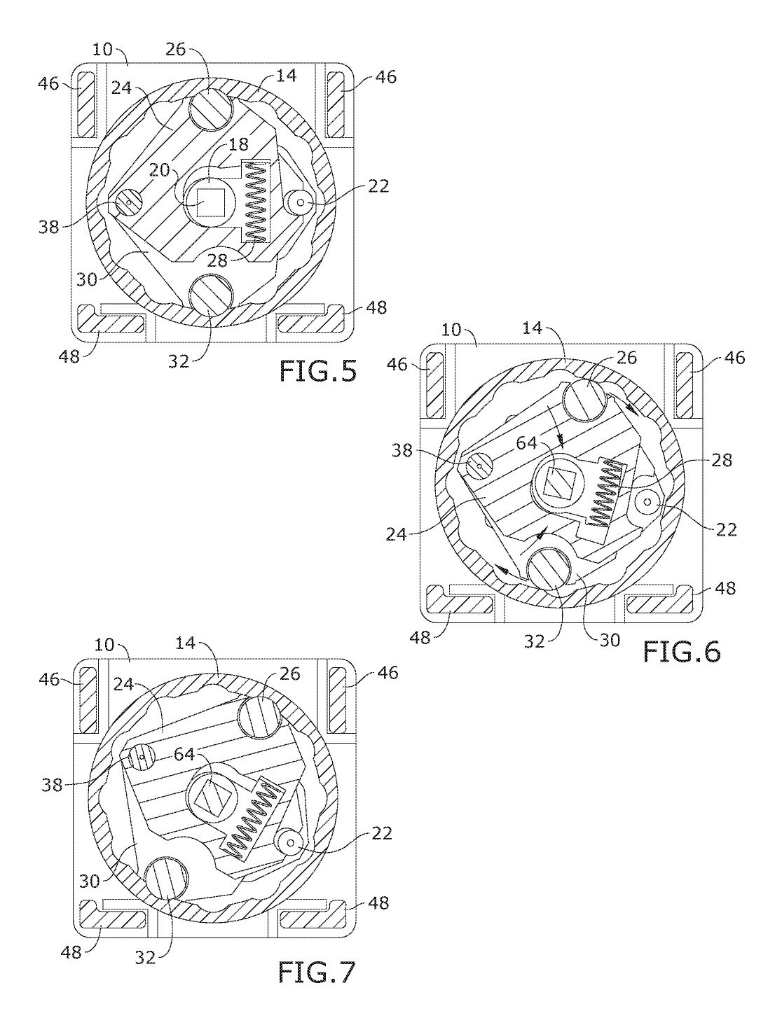

Referring now to FIGS. 1 through 7, the present invention may include a capstan spool 34 that is built into the winch 100, which in turn is coupled with a locking and motivating device, for selectively operating a halyard 60 engaging the capstan spool 34. In the present invention, the halyard 60 ends are interconnected to each other by a tension device 68 defining a closed loop halyard 60. The tension device 68 may be a helical spring, a bungy cord, or similar device for maintaining sufficient tension along the halyard 60. The rigidity of the halyard 60 maintains its integrity and thus the tension urged through it by way of the tension device 68. The halyard 60 may be a wire core halyard, or other sufficient strong material that prevents the halyard 60 from over-stretching, which could defeat its purpose; excessive loosening of the halyard 60 may cause the halyard 60 to stop moving. The closed-loop halyard 60 combined with the tension device 68 enables positively raising and lowering the halyard 60 without the need for additional mass or weights with the halyard is totally contained in the capstan winch 100.

The capstan spool 34 is rotatably mounted to the winch 100. The capstan spool 34 may be defined by two conical shapes joined at their apexes, with the conical bases on the outside of the spool. It should also be noted that the shape of capstan spool 34 may be configured in many forms having a narrower center diameter relative to the larger end diameters, so long as the capstan spool 34 functions in accordance with the present invention as described herein.

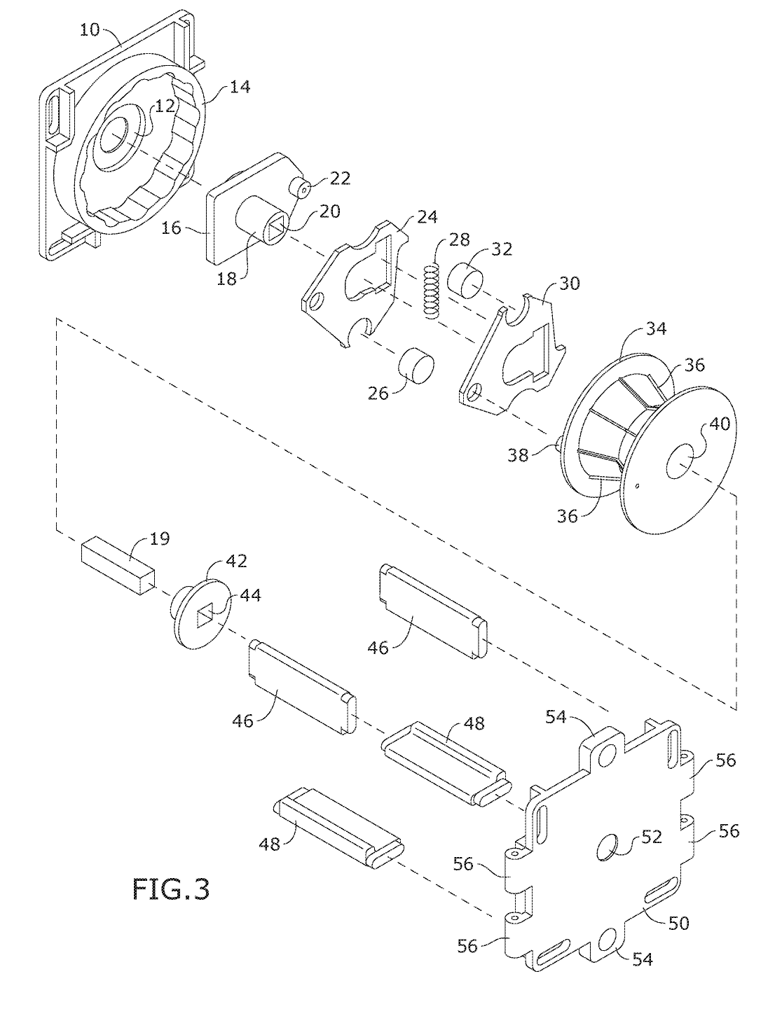

Specifically, referring to FIG. 3, the capstan spool 34 may have a spool slot 40 extending through its rotational axis, wherein the spool slot 40 is dimensioned and adapted to slidably receive an axle 19. From one outward facing end of the spool 34 a spool post 38 may protrude. The drive assembly of the present invention may include a pair of mirror-image pawl plates 24 and 30, each having an aperture in one end pivotally receiving the spool post 38. The pawl plates 24 and 30 also have a central opening loosely receiving a pawl release shaft 18 extending from a pawl release mechanism 16 stacked against a cam plate 10, wherein the pawl release mechanism 16 includes a pawl release post 22. The pawl release shaft 18 provides a pawl release slot. The cam plate 10 provides a paw release mechanism slot 12 for nesting a portion of the pawl release mechanism 16. The cam plate 10 also provides a roller guide plate 14 or stationary ring-gear-like cam concentric with the rotational axis and surrounding the release mechanism 16 and pawl plates 24 and 30. The roller guide plate 14 has inwardly facing peaks and valleys adapted to engage rollers 26, 32 also engaged by C-shaped cutouts in the pawl plates 24 and 30. A spring mechanism 28 biases the pawl plates 24 and 30 with their pawl detents outward. The winch 100 may include a bearing 42 having a bearing slot 44 therein for engaging the axle 19. The winch 100 may include upper and lower spacers 46 and 48, a back plate 50, a back plate slot 52, mounting tabs 54 for mounting bolts 62, and side knuckles 56 as illustrated in the FIGS.

In use, the halyard 60 is connected to an object (not shown) such as a flag. Also, the closed loop halyard 60 may be wound around the capstan spool 34 a few times then connected to the top flagpole pulley (not shown). Moreover, the tension device 68 urges a grip on the capstan spool 34 giving the halyard 60 motion up and down when motivated by a drive assembly or cranking tool 64, and so raising the flag becomes much quicker and easier. Alternatively, the present invention may be used to move other objects along any plane with some precision.

The capstan spool 34 may provide peripheral cleats 36 to grab the halyard 60 and so that the halyard 60 may move around the spool 34 without walking on itself in an endless fashion in either direction.

The capstan spool 34 may be rotated by use of a cranking tool 64. The cranking tool 64 may include a handheld drive unit 66, such as a handheld power tool. The cranking tool 64 causes the closed-loop halyard 60 to selectively be risen or lowered, wherein the peripheral cleats 36 on the capstan spool 34 grab the halyard 60, moving the flag up the flagpole 58. The winch 100 allows the flag to be positioned anywhere up the flagpole 58, for example at half mast, whereat the flag stays pat because of the cleated capstan spool 34, tension of the tension device 68 on the halyard 60 and the winch locking mechanisms and/or release components.

The present invention may be manufactured through 3D printing (additive manufacture), molding, stamping and the like, using sufficiently strong materials, such as steel, various plasticized materials and the like.

It should be understood, of course, that the foregoing relates to exemplary embodiments of the invention and that modifications may be made without departing from the spirit and scope of the present invention.

1. A flagpole winch system, comprising:
a winch attached along an exterior of a flagpole;
a capstan spool rotatably mounted to the winch; and
a closed-loop halyard engaging the capstan spool.

2. The flagpole winch system of claim 1, further comprising a tension device incorporated into the closed-loops halyard.

3. The flagpole winch system of claim 1, further comprising spaced apart peripheral cleats provided along a periphery of the capstan spool.

4. The flagpole winch system of claim 3, wherein the spaced apart peripheral cleats extend longitudinally between opposing first and second ends of the capstan spool.

5. The flagpole winch system of claim 1, wherein a periphery of the capstan spool has a narrower center diameter relative to diameters of first and second ends of the capstan spool.

6. A flagpole winch system, comprising:
a winch attached along an exterior of a flagpole;
a capstan spool rotatably mounted to the winch;
spaced apart peripheral cleats provided along a periphery of the capstan spool, wherein said periphery has a narrower center diameter relative to diameters of first and second ends thereof, and wherein the spaced apart peripheral cleats extend longitudinally between said first and second ends; and
a closed-loop halyard engaging the capstan spool, wherein the closed-loop halyard incorporates a tension device.

7. A winch system, comprising:
a capstan spool rotatably mounted to a winch; and
a closed-loop halyard engaging the capstan spool.

8. The winch system of claim 7, further comprising:
spaced apart peripheral cleats provided along a periphery of the capstan spool, wherein said periphery has a narrower center diameter relative to diameters of first and second ends thereof, and wherein the spaced apart peripheral cleats extend longitudinally between said first and second ends; and
a tension device incorporated in the closed-loop halyard.
